(19) United States
(12) Patent Application Publication
(10) Pub. No.: US 2013/0138520 A1
(43) Pub. Date: May 30, 2013

(54) METHOD FOR ACQUIRING DATA FROM A POINT OF SALE (POS) SYSTEM BY AN ELECTRONIC LABEL SYSTEM, THE ELECTRONIC LABEL SYSTEM, AND POS LABEL MANAGEMENT SYSTEM

(71) Applicant: Hardware & Software Technology Co., Ltd., Taoyuan Hsien (TW)

(72) Inventors: WEN-LIANG HU, TAOYUAN HSIEN (TW); SHIH-CHIEN HUANG, TAOYUAN HSIEN (TW); TSAN-SHUN CHEN, TAOYUAN HSIEN (TW); CHEE-KONG CHONG, TAOYUAN HSIEN (TW)

(73) Assignee: HARDWARE & SOFTWARE TECHNOLOGY CO., LTD., Taoyuan Hsien (TW)

(21) Appl. No.: 13/666,145

(22) Filed: Nov. 1, 2012

(30) Foreign Application Priority Data
Nov. 30, 2011 (TW) 100143837
Mar. 23, 2012 (CN) 201210081931.X

(51) Int. Cl. G06Q 20/20

(52) U.S. Cl. 705/17; 705/21

(57) ABSTRACT

A method for acquiring data from a point-of-sale (POS) system is executed by an electronic label system. The electronic label system includes a host and a virtual printer unit operable to communicate with the host over a network. The POS system is operable to obtain sales information from a database thereof and to transmit the sales information to the virtual printer unit. In the method, the virtual printer unit is configured to convert the sales information into print data that can be recognized by the host, and to transmit the print data to the host through the network.

### CROSS-REFERENCE TO RELATED APPLICATION

This application claims priority of Taiwanese Application No. 100143837, filed on Nov. 30, 2011 and Chinese Application No. 201210081931.X, filed on Mar. 23, 2012.

### BACKGROUND OF THE INVENTION

1. Field of the Invention

The invention relates to a method for acquiring data from a point-of-sale (POS) system by an electronic label system, and a POS label management system.

2. Description of the Related Art

A conventional electronic shelf label system (as disclosed in U.S. Patent Application Publication No. US 2002/0002421 A1) has been designed to replace paper-made labels, which need to be printed, cut and placed manually, every time information of commercial articles printed on the paper-made labels is changed.

Generally, a conventional electronic shelf label system includes a host and a plurality of electronic labels. The host of the conventional electronic shelf label system is configured to communicate with a point-of-sale (POS) system for acquiring sales information therefrom. The electronic labels are operable to receive the sales information from the host and to display the sales information.

Typically, the conventional electronic shelf label system and the POS system are manufactured by different manufacturers. As a result, different configurations between the electronic shelf label system and the POS system may bring about a number of difficulties. For example, in order to communicate with the POS system properly, it is difficult to perform setup procedures on the electronic shelf label system and/or the POS system for accessing a database, which stores the sales information of the POS system. Moreover, the sales information that is originally stored in the database of the POS system may be in a format unrecognizable to the electronic shelf label system, and thus cannot be displayed.

### SUMMARY OF THE INVENTION

Therefore, an object of the present invention is to provide a method for an electronic label system to acquire data from a POS system with relative ease.

Accordingly, a method of the present invention is for acquiring data from the POS system by the electronic label system. The POS system includes a database storing sales information of commercial articles and a control unit coupled to the database. The electronic label system includes a host, and a virtual printer unit coupled to the control unit of the POS system and operable to communicate with the host of the electronic label system over a network. The control unit is operable to obtain the sales information from the database and to transmit the sales information to the virtual printer unit. The method comprises the following steps of:

configuring the virtual printer unit to convert the sales information into print data that can cooperate by the host; and

configuring the virtual printer unit to transmit the print data to the host through the network.

Another object of the present invention is to provide an electronic label system that can be integrated with various POS systems with different configurations.

Accordingly, an electronic label system of the present invention is configured to acquire data from a point-of-sale (POS) system. The POS system includes a database storing sales information of commercial articles and a control unit coupled to the database. The control unit is operable to obtain the sales information from the database. The electronic label system includes a host and a virtual printer unit coupled to the control unit and configured to:

communicate with the host over a network;

obtain the sales information from the database via the control unit;

convert the sales information into print data that can be recognized by said host; and

transmit the print data to the host through the network.

Yet another object of the present invention provide a point-of-sale (POS) label management system that integrates the POS system and the electronic label system for executing the aforementioned method.

Accordingly, a POS label management system of the present invention includes a SOS system and an electronic label system.

The POS system includes a database for storing with sales information of commercial articles, and a control unit coupled to the database. The control unit is operable to obtain the sales information from the database.

The electronic label system includes a host and a virtual printer unit coupled to the first control unit and configured to:

communicate with the host over a network;

obtain the sales information from the database via the first control unit;

convert the sales information into print data that can be recognized by the host; and

transmit the print data to the host through the network.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a preferred embodiment of a point-of-sale (POS) label management system according to the invention;

FIG. 2 is a flowchart of a preferred embodiment of a method for acquiring data from a POS system by an electronic label system according to the invention; and

FIG. 3 illustrates an exemplary arrangement of the POS label management system.

### DETAILED DESCRIPTION OF THE PREFERRED EMBODIMENTS

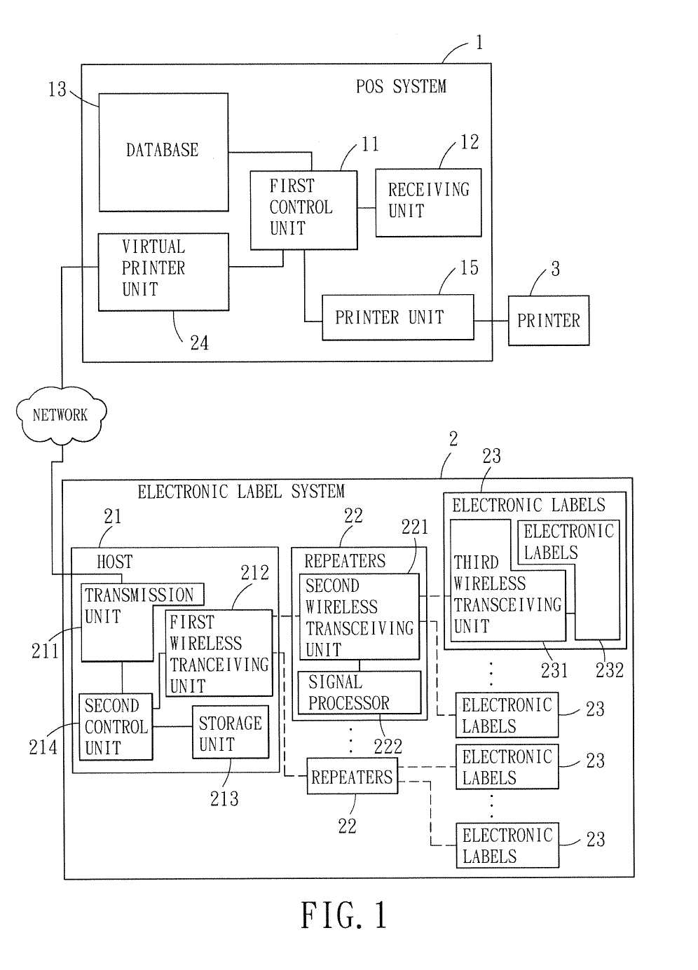

As shown in FIG. 1, the preferred embodiment of a point-of-sale (POS) label management system according to the present invention is illustrated. The POS label management system comprises a POS system 1 and an electronic label system 2.

The POS system 1 includes a first control unit 11, a receiving unit 12, a database 13, and a printer unit 15. The database 13 stores sales information of commercial articles, and is coupled to the first control unit 11. The electronic label system 2 includes a host 21, a plurality of repeaters 22, a plurality of electronic labels 23 and a virtual printer unit 24. The virtual printer unit 24 is coupled to the first control unit 11 of the POS system 1, and is operable to communicate with the host 21 over a network. In this embodiment, the network can be a local area network (LAN) constructed using a network platform (not shown), and Transmission Control Protocol/Internet Protocol (TCP/IP) is used for communication between the host 21 and the virtual printer unit 24 over the network. The host 21 includes a transmission unit 211, a first wireless transceiving unit 212, a storage unit 213, and a second control unit 214.

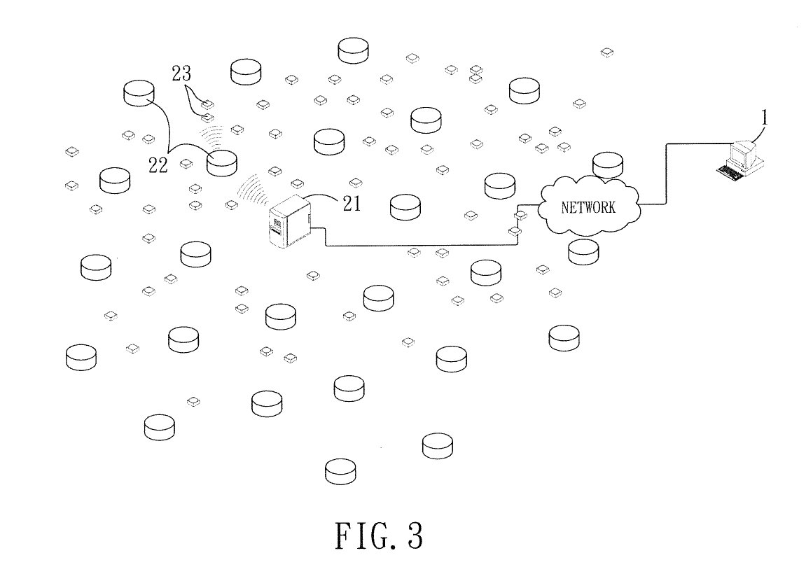

Each of the repeaters 22 includes a second wireless transceiving unit 221 and a signal processor 222 that is for interpreting the message received from the transceiving unit 221 and forwarding them to other repeaters 22, using the second wireless transceiving unit 221. The repeaters 22 can wirelessly transmit the print data incorporated in the signal to the electronic labels 23, and are used in order to ensure that the signal from the host 21 can be received by each of the electronic label 23, since the electronic labels 23 may be disposed separately in a large area (e.g., a wholesale store, see FIG. 3) and may be distant from the host 21.

Each of the electronic labels 23 includes a third wireless transceiving unit 231 and a display unit 232. The display unit 232 is an electronic paper module in this embodiment, but can be other media operable to display information thereon in other embodiments.

The virtual printer unit 24 is configured to convert the sales information into print data that can be recognized by the host 21. As a result, the difficulty in displaying the sales information attributed to the different configurations of the POS system 1 and the electronic system 2 can be eliminated.

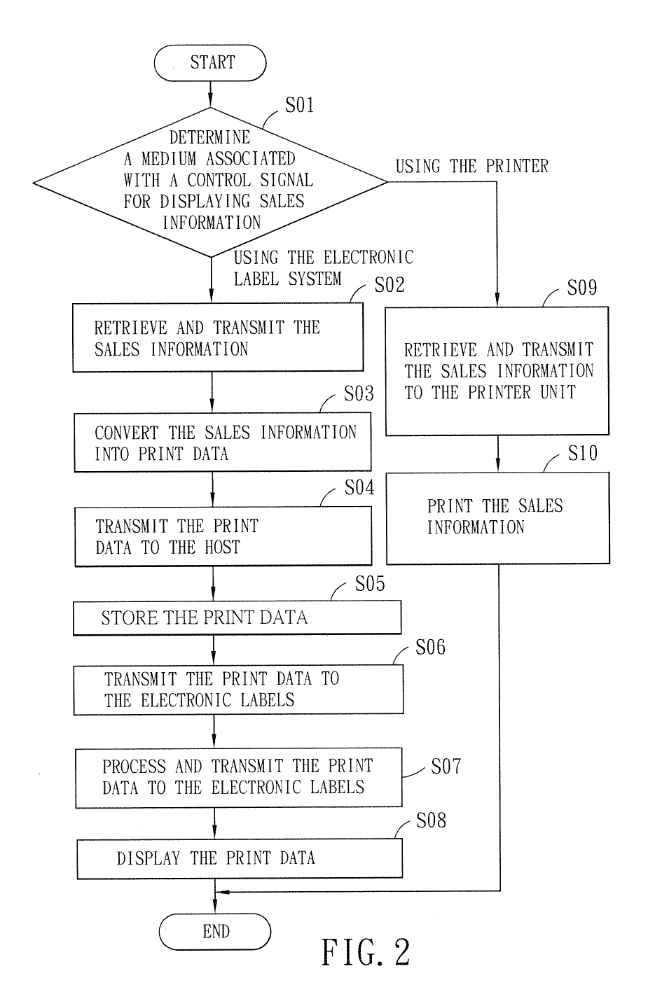

Reference is now made to FIG. 2, which illustrates steps of a method for acquiring data from the POS system 1 by the electronic label system 2.

In step S01, the receiving unit 12 receives a control signal, which requests the sales information of a desired one of the commercial articles to be displayed, from a user, and the first control unit 11 is operable to perform different operations based on the type of the control signal. The type of the control signal is associated with a medium for displaying the sales information of the desired commercial article. For example, when the user desires to print the sales information on real paper, a control signal directed to the printer unit 15 is inputted by the user and transmitted to the receiving unit 12, and the flow proceeds to step S09. When the user desires to display the sales information using the electronic labels 23 of the electronic label system 2, a control signal directed to the virtual printer unit 24 is inputted by the user to the receiving unit 12, and the flow proceeds to step S02.

In step S02, the first control unit 11 is operable to retrieve the sales information of the desired one of the commercial articles requested by the control signal from the database 13, and to transmit the sales information of the desired one of the commercial articles to the virtual printer unit 24.

Then, the virtual printer unit 24 is operable to convert the sales information into the print data in step S03, and to transmit the print data to the host 21 through the network in step S04. In this embodiment, the print data is first transmitted to the network platform, which then forwards the print data to the first wireless transceiving unit 212 of the host 21.

Upon receipt of the print data, the host 21 is operable to store the print data in the storage unit 213 in step S05, and to use the first wireless transceiving unit 212 to transmit the print data to the electronic labels 23 (that are within the effective range of the first wireless transceiving unit 212) and the second wireless transceiving units 221 of the repeaters 22 in step S06. In practice, the host 21 may directly transmit the print data using the first wireless transceiving unit 212 to the electronic labels 23 located within an effective range of the first wireless transceiving unit 212 without going through the repeaters 22.

In step S07, each of the repeaters 22 is operable to process the signal for transmitting the print data (i.e., interpreting the message and forwarding) using the signal processor 222, and to wirelessly transmit the print data incorporated in the processed signal to the third wireless transceiving units 231 of the electronic labels 23 that are not within the effective range of the first wireless transceiving unit 212 using the second wireless transceiving unit 221.

In step S08, each of the electronic labels 23 that receive the print data from the host 21 and/or the repeater 22 is operable to display the print data using the display unit 232 thereof.

Alternatively, when it is determined in step S01 that the type of the control signal is associated with real paper, that is to say, the user desires to print the sales information of the desired one of the commercial articles using real paper, the first control unit 11 is operable to retrieve the sales information of the desired one of the commercial articles requested by the control signal from the database 13, and to transmit the sales information of the desired one of the commercial articles to the printer unit 15 in step S09. Then, the printer unit 15 is operable to control operation of a printer 3 coupled to the printer unit 15 to print the sales information in step S10.

It is noted that the virtual printer unit 24 can be in the form of one of a physical device attached to the POS system 1 and an executable program installed in the POS system 1. As a result, even though the POS system 1 is incompatible with the electronic label system 2, the electronic label system 2 can be integrated and thus cooperate with the POS system 1 through the virtual printer unit 24 without significantly altering the POS system 1.

To sum up, in the present invention, the virtual printer unit 24 of the electronic label system 2 is configured to obtain the sales information from the POS system 1, and is able to convert the sales information into the print data that can be recognized by the host 21 of the electronic label system 2. Therefore, the electronic label system 2 is able to obtain the sales information in the form of the print data, which can be displayed by the display units 232 of the electronic labels 23. Accordingly, the electronic label system 2 is relatively easy to be integrated and cooperate with various POS systems 1 having different configurations.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for acquiring data from a point-of-sa le (POS) system by an electronic label system, the POS system including a database that stores sales information of commercial articles and a control unit that is coupled to the database, the electronic label system including a host, and a virtual printer unit that is coupled to the control unit of the POS system and that is operable to communicate with the host of the electronic label system over a network, the control unit being operable to obtain the sales information from the database and to transmit the sales information to the virtual printer unit, said method comprising the following steps of:
(a) configuring the virtual printer unit to convert the sales information into print data that can be recognized by the host; and
(b) configuring the virtual printer unit to transmit the print data to the host through the network.

2. The method as claimed in claim 1, the electronic label system further including at least one electronic label having a display unit, said method further comprising, after step (b), the following steps of:
(c) configuring the host to transmit the print data to the electronic label; and
(d) configuring the display unit of the electronic label to display the print data.

3. The method as claimed in claim 2, the electronic label system further including a repeater that includes a signal processor for interpreting and forwarding the print data, wherein, in step (c), the host is configured to transmit the print data to the repeater, and the repeater is configured to wirelessly transmit the print data incorporated in the processed signal to the electronic label.

4. The method as claimed in claim 2, wherein in step (c), the host is further configured to store the print data received in step (b).

5. An electronic label system configured to acquire data from a point-of-sale (POS) system, the POS system including a database that stores sales information of commercial articles and a control unit that is coupled to the database, the control unit being operable to obtain the sales information from the database, said electronic label system comprising:
a host; and
a virtual printer unit coupled to the control unit and configured to communicate with said host over a network, to obtain the sales information from the database via the control unit, to convert the sales information into print data that can be recognized by said host, and to transmit the print data to said host through the network.

6. The electronic label system as claimed in claim 5, further comprising at least one electronic label including a display unit,
wherein said host is configured to transmit to said electronic label the print data received from said virtual printer unit, and said display unit of said electronic label is configured to display the print data.

7. The electronic label system as claimed in claim 6, wherein:
said host includes a first wireless transceiving unit for receiving the print data from said virtual printer unit;
said electronic label system further comprises a repeater that includes a second wireless transceiving unit for receiving the print data from said first wireless transceiving unit of said host, and a signal processor for filtering noise and amplifying magnitude of the print data; and
said electronic label further includes a third wireless transceiving unit coupled to said display unit, and said second wireless transceiving unit of said repeater is configured to wirelessly transmit the print data incorporated in the processed signal to said third wireless transceiving unit of said electronic label.

8. The electronic label system as claimed in claim 5, wherein said host includes a storage unit that is configured to store the print data.

9. A point-of-sale (POS) label management system, comprising:
a POS system including a database that is configured for storing sales information of commercial articles and a control unit that is coupled to said database, said control unit being operable to obtain the sales information from said database; and
an electronic label system including:
a host; and
a virtual printer unit coupled to said control unit and configured to communicate with said host over a network, to obtain the sales information from said database via said control unit, to convert the sales information into print data that can be recognized by said host, and to transmit the print data to said host through the network.

10. The POS label management system as claimed in claim 9, wherein said electronic label system further includes at least one electronic label including a display unit, said host is configured to transmit to said electronic label the print data received from said virtual printer unit, and said display unit of said electronic label is configured to display the print data.

11. The POS label management system as claimed in claim 10, wherein:
said host includes a first wireless transceiving unit for receiving the print data from said virtual printer unit,
said electronic label system further includes a repeater that includes a second wireless transceiving unit for receiving the print data from said first wireless transceiving unit of said host, and a signal processor for interpreting and forwarding wireless packets for transmitting the print data; and
said electronic label further includes a third wireless transceiving unit coupled to said display unit, and said second wireless transceiving unit of said repeater is configured to wirelessly transmit the print data incorporated in the processed signal to said third wireless transceiving unit of said electronic label.

12. The POS label management system as claimed in claim 9, wherein said host further includes a storage unit that is configured to store the print data.
